(19) United States
(12) Patent Application Publication
(10) Pub. No.: US 2025/0210904 A1
(43) Pub. Date: Jun. 26, 2025

(54) ELECTRICAL CONNECTION DEVICE HAVING AUTOMATIC RESET FUNCTION FOR PLUGGING AND UNPLUGGING

(71) Applicant: NEXTRONICS ENGINEERING CORP., NEW TAIPEI CITY (TW)

(72) Inventors: CHIH-HSIUNG HSU, NEW TAIPEI CITY (TW); YONG ZHANG, GUANGZHOU CITY (CN)

(21) Appl. No.: 18/610,335

(22) Filed: Mar. 20, 2024

(30) Foreign Application Priority Data
Dec. 21, 2023 (CN) 202311775384.X

(51) Int. Cl. H01R 13/502; H01R 13/52; H01R 13/629

(52) U.S. Cl. CPC H01R 13/502; H01R 13/5202; H01R 13/629

(57) ABSTRACT

An electrical connection device having an automatic reset function for plugging and unplugging includes a first connector and a second connector. The first connector includes a first plastic core, first terminals, an inner casing member, an elastic element, and an outer casing member. The first terminals are disposed on the first plastic core, and each of the first terminals has a first contact end and a first connection end. The inner casing member is disposed outside the first plastic core, an outer side of the inner casing member has an accommodating seat disposed thereon, and the accommodating seat has an accommodating groove. The elastic element is able to be placed in the accommodating groove along the axial direction of the inner casing member through the opening. The second connector includes a second plastic core, second terminals, and an outer housing.

### CROSS-REFERENCE TO RELATED PATENT APPLICATION

This application claims the benefit of priority to China Patent Application No. 202311775384.X, filed on Dec. 21, 2023, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electrical connection device, and more particularly to an electrical connection device having an automatic reset function for plugging and unplugging.

### BACKGROUND OF THE DISCLOSURE

An existing connection device includes a first connector and a second connector, and the first connector and the second connector may be disposed in a plug connector and a socket connector, respectively. The first connector and the second connector may be inserted with each other to achieve an electrical connection. In order to provide a secure bonding between the first connector and the second connector that are inserted with each other, a locking structure is usually provided between the first connector and the second connector. Furthermore, an elastic element is disposed in the first connector or the second connector to provide kinetic energy for resetting. Due to the design of the elastic element, special jigs are required for the assembly of the housing of the connectors, causing inconvenience in the assembly.

### SUMMARY OF THE DISCLOSURE

In response to the above-referenced technical inadequacies, the present disclosure provides an electrical connection device having an automatic reset function for plugging and unplugging. The electrical connection device has a simple structure and enables an assembly process to be convenient and fast to facilitate the manufacturing of the electrical connection device.

In order to solve the above-mentioned problems, one of the technical aspects adopted by the present disclosure is to provide an electrical connection device having an automatic reset function for plugging and unplugging. The electrical connection device includes a first connector and a second connector. The first connector includes a first plastic core, a plurality of first terminals, an inner casing member, an elastic element, and an outer casing member. The plurality of first terminals are disposed on the first plastic core, and each of the plurality of first terminals has a first contact end and a first connection end. The inner casing member is disposed outside the first plastic core, an outer side of the inner casing member has an accommodating seat disposed thereon, and the accommodating seat has an accommodating groove. An opening is formed on one side of the accommodating seat, the opening is in spatial communication with the accommodating groove, and the opening faces an axial direction of the inner casing member. The elastic element is able to be placed in the accommodating groove along the axial direction of the inner casing member through the opening, the outer casing member sleeves on the outer side of the inner casing member, two ends of the elastic element are respectively in contact with the inner casing member and the outer casing member, and an inner side of the outer casing member has at least one engaging body disposed thereon. The second connector includes a second plastic core, a plurality of second terminals, and an outer housing. The plurality of second terminals are disposed on the second plastic core, and each of the plurality of second terminals has a second contact end and a second connection end. The outer housing is disposed outside the second plastic core, and at least one engaging groove is formed on an outer side of the outer housing. When the first connector and the second connector are inserted with each other, the first contact ends of the plurality of first terminals are respectively in contact with the second contact ends of the plurality of second terminals to form an electrical connection, and the engaging body and the engaging groove are capable of being engaged with each other.

Therefore, in the electrical connection device having an automatic reset function for plugging and unplugging provided by the present disclosure, the electrical connection device includes a first connector and a second connector. The first connector includes a first plastic core, a plurality of first terminals, an inner casing member, an elastic element, and an outer casing member. The plurality of first terminals are disposed on the first plastic core, and each of the plurality of first terminals has a first contact end and a first connection end. The inner casing member is disposed outside the first plastic core, an outer side of the inner casing member has an accommodating seat disposed thereon, and the accommodating seat has an accommodating groove. An opening is formed on one side of the accommodating seat, the opening is in spatial communication with the accommodating groove, and the opening faces an axial direction of the inner casing member. The elastic element is able to be placed in the accommodating groove along the axial direction of the inner casing member through the opening, the outer casing member sleeves on the outer side of the inner casing member, two ends of the elastic element are respectively in contact with the inner casing member and the outer casing member, and an inner side of the outer casing member has at least one engaging body disposed thereon. The second connector includes a second plastic core, a plurality of second terminals, and an outer housing. The plurality of second terminals are disposed on the second plastic core, and each of the plurality of second terminals has a second contact end and a second connection end. The outer housing is disposed outside the second plastic core, and at least one engaging groove is formed on an outer side of the outer housing. When the first connector and the second connector are inserted with each other, the first contact ends of the plurality of first terminals are respectively in contact with the second contact ends of the plurality of second terminals to form an electrical connection, and the engaging body and the engaging groove are capable of being engaged with each other, such that the first connector and the second connector are fixedly locked together. In the present disclosure, the elastic element is able to be assembled to the accommodating groove along the axial direction of the inner casing member, and the outer casing member can be assembled without using any specialized assembly jig, thereby enabling a convenient and fast assembly. Furthermore, the present disclosure has a simplified structure that is conducive to manufacturing and assembly.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an electrical connection device having an automatic reset function for plugging and unplugging according to the present disclosure;

FIG. 2 is another schematic view of the electrical connection device according to the present disclosure;

FIG. 3 is a cross-sectional view taken along line III-III of FIG. 1;

FIG. 4 is a schematic exploded view of a first connector according to the present disclosure;

FIG. 5 is a schematic exploded view of a second connector according to the present disclosure;

FIG. 6 is a cross-sectional view taken along line VI-VI of FIG. 3;

FIG. 7 is a schematic view of an outer casing member according to the present disclosure;

FIG. 8 is a schematic exploded view of the first connector and the second connector inserted with each other according to the present disclosure; and

FIG. 9 is a cross-sectional view of a second terminal according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### EMBODIMENTS

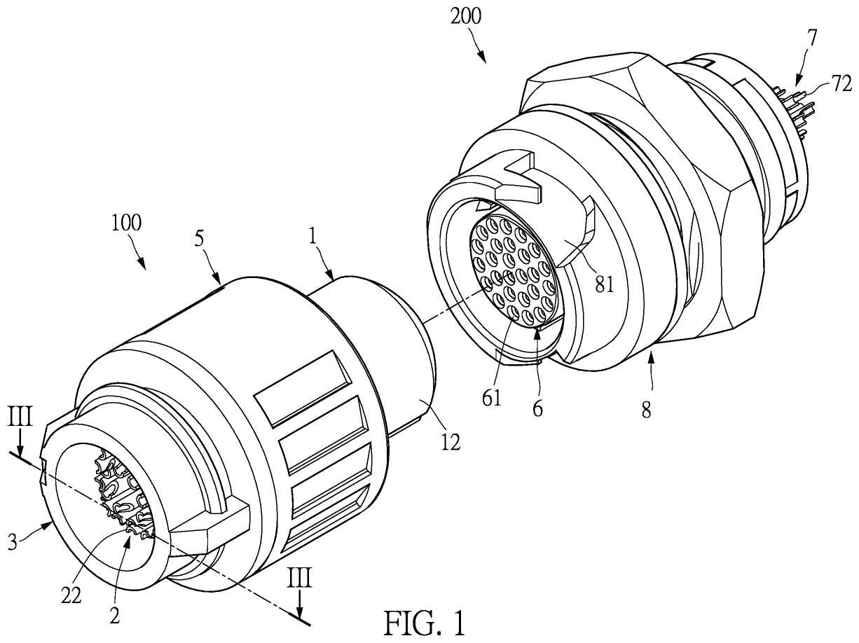

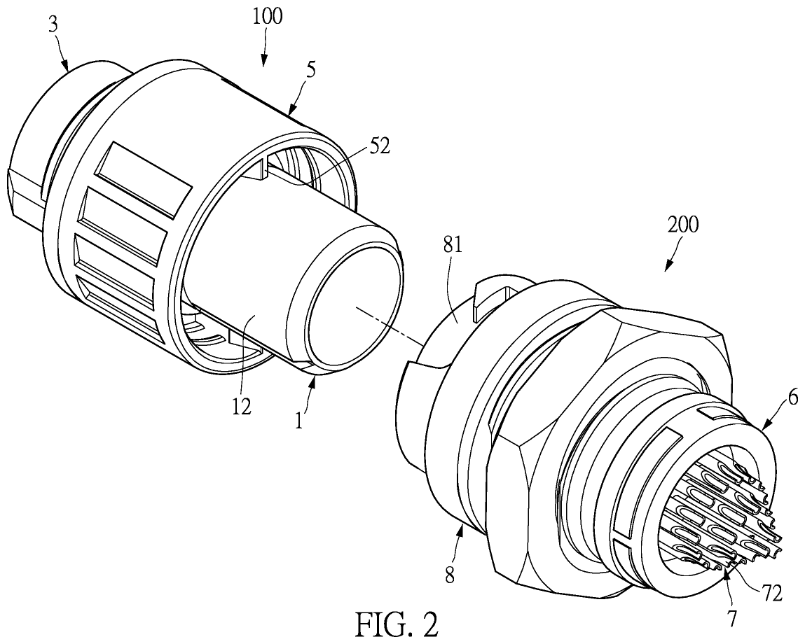

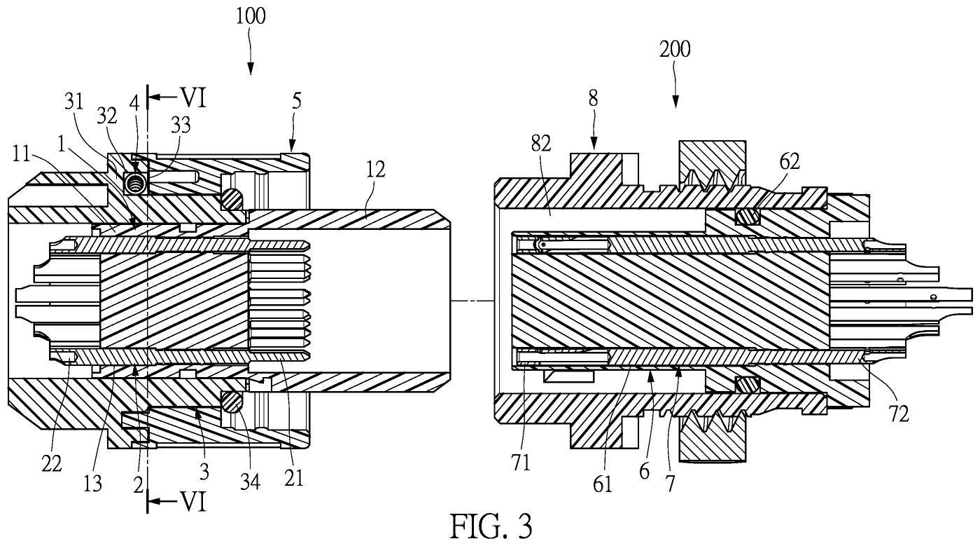

Referring to FIG. 1 to FIG. 3, the present disclosure provides an electrical connection device having an automatic reset function for plugging and unplugging. The electrical connection device includes a first connector 100 and a second connector 200.

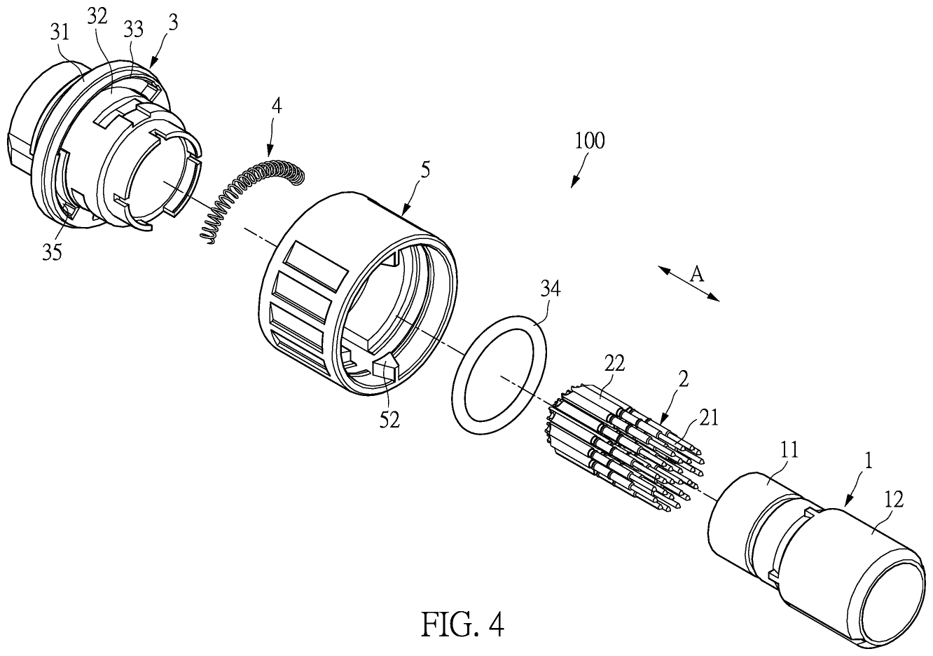

Referring to FIG. 4, the first connector 100 can be a plug connector. The first connector 100 includes a first plastic core 1, a plurality of first terminals 2, an inner casing member 3, an elastic element 4, and an outer casing member 5.

The first plastic core 1 is made of materials such as plastic, and the first plastic core 1 can be cylinder-shaped. The first plastic core 1 can include a body portion 11 and a sleeve portion 12. A plurality of first terminal holes 13 are formed in the first plastic core 1, and the plurality of first terminal holes 13 pass through two ends of the first plastic core 1. One end of the sleeve portion 12 is connected to one end of the body portion 11, and the sleeve portion 12 is a hollow cylinder.

The plurality of first terminals 2 are made of electrically conductive metal materials such as copper, and the plurality of first terminals 2 are disposed on the first plastic core 1. The plurality of first terminals 2 can be male terminals, and each of the plurality of first terminals 2 has a first contact end 21 and a first connection end 22. The plurality of first terminals 2 can be respectively disposed in the plurality of first terminal holes 13, such that the plurality of first terminals 2 are disposed on the body portion 11. Furthermore, the first contact ends 21 and the first connection ends 22 of the plurality of first terminals 2 can respectively extend outward from the two ends of the body portion 11. The first connection ends 22 of the plurality of first terminals 2 can be used to connect to devices such as cables, and the first contact ends 21 of the plurality of first terminals 2 can extend into the sleeve portion 12 of the first plastic core 1.

The inner casing member 3 is made of plastic or other materials, the inner casing member 3 may be a hollow cylinder, and the inner casing member 3 is disposed outside the body portion 11 of the first plastic core 1. The first connection ends 22 of the first terminals 2 may extend into the inner casing member 3, such that the first connection ends 22 of the first terminals 2 receive improved protection. As shown in FIG. 4, an outer side of the inner casing member 3 has an accommodating seat 31 disposed thereon, the accommodating seat 31 can be a ring-shaped seat, and the accommodating seat 31 has an accommodating groove 32. The accommodating groove 32 extends in an arc-shape, and the accommodating groove 32 extends for a predetermined length in a circumferential direction of the inner casing member 3. An opening 33 is formed on one side of the accommodating seat 31, and the opening 33 is in spatial communication with the accommodating groove 32. The opening 33 faces a front of the first connector 100, i.e., a direction of insertion of the first connector 100. A first sealing ring 34 can also sleeve on the outer side of the inner casing member 3, and the first sealing ring 34 is adjacent to the sleeve portion 12 of the first plastic core 1, so as to improve a sealing effect when the first connector 100 and the second connector 200 are inserted with each other.

The elastic element 4 is a compression spring, and the elastic element 4 can be placed in the accommodating groove 32 along an axial direction A (as shown in FIG. 4) of the inner casing member 3 through the opening 33. When the elastic element 4 is placed in the accommodating groove 32, the accommodating groove 32 can be used to limit the elastic element 4, such that the elastic element 4 forms a corresponding arc-shape and does not spring into a linear shape, thereby facilitating the assembly of the elastic element 4 and the outer casing member 5.

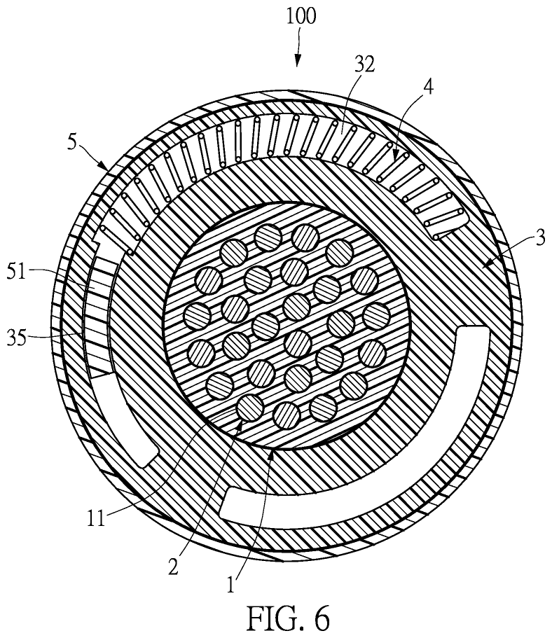

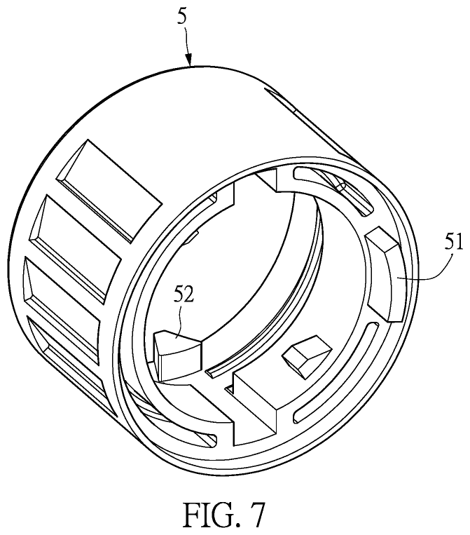

The outer casing member 5 is made of plastic or other materials. The outer casing member 5 is disposed outside the inner casing member 3, and the elastic element 4 is disposed between the inner casing member 3 and the outer casing member 5. That is, the two ends of the elastic element 4 are respectively in contact with the inner casing member 3 and the outer casing member 5 to provide a rotational reset force. In this embodiment, the outer casing member 5 has a stopping block 51 (as shown in FIG. 6 and FIG. 7) disposed thereon, and the two ends of the elastic element 4 can respectively abut against one end of the accommodating groove 32 and the stopping block 51. Therefore, the elastic element 4 can stably apply the rotational reset force to the outer casing member 5, so as to provide a function of automatic reset for plugging and unplugging. An inner side of the outer casing member 5 has at least one engaging body 52 disposed thereon. In this embodiment, the inner side of the outer casing member 5 has two engaging bodies 52 disposed thereon.

In this embodiment, an arched groove 35 is formed in the accommodating seat 31, and the arched groove 35 extends in an arc-shape. The arched groove 35 extends for a predetermined length in the circumferential direction of the inner casing member 3, and the arched groove 35 is connected to the accommodating groove 32. The stopping block 51 may be arc-shaped, the stopping block 51 is movably disposed in the arched groove 35, and the stopping block 51 may move in the arched groove 35 and the accommodating groove 32 to compress and release the elastic element 4, such that the elastic element 4 can stably apply the rotational reset force to the outer casing member 5.

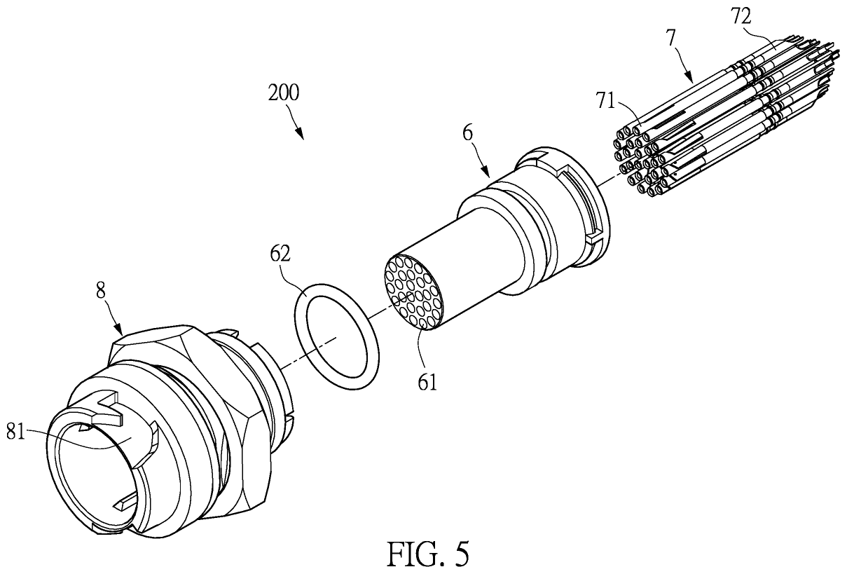

Referring to FIG. 5, the second connector 200 may be a socket connector, and the second connector 200 includes a second plastic core 6, a plurality of second terminals 7, and an outer housing 8. The second plastic core 6 is made of plastic or other materials, a plurality of second terminal holes 61 may be formed in the second plastic core 6, and the second terminal holes 61 pass through two ends of the second plastic core 6. A second sealing ring 62 may sleeve on an outer side of the second plastic core 6, and the second sealing ring 62 is located between the second plastic core 6 and the outer housing 8 to improve the sealing effect.

The plurality of second terminals 7 are made of electrically conductive metal materials such as copper, and the plurality of second terminals 7 are disposed on the second plastic core 6. The plurality of second terminals 7 can be female terminals, and each of the plurality of second terminals 7 has a second contact end 71 and a second connection end 72. The plurality of second terminals 7 can be respectively disposed in the second terminal holes 61, and the second connection ends 72 of the plurality of second terminals 7 extend outward from the second plastic core 6. The second connection ends 72 of the plurality of second terminals 7 can be used to connect to devices such as cables.

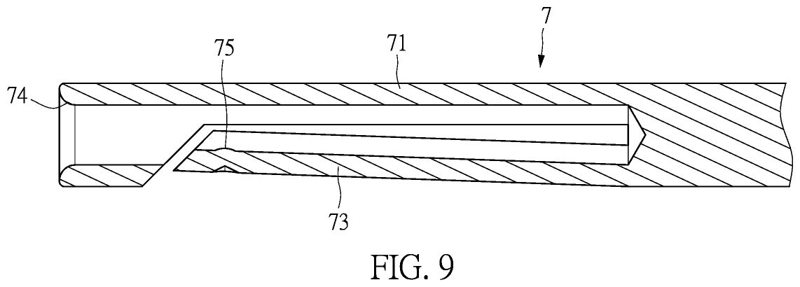

In this embodiment, the plurality of second terminals 7 are female terminals. The second contact end 71 of each of the plurality of second terminal 7 is hollowed (as shown in FIG. 9), and an elastic arm 73 is disposed on one side of the second contact end 71 of each of the plurality of second terminals 7. One end (a rear end) of the elastic arm 73 is fixed to the second contact end 71, and another end (a front end) of the elastic arm 73 forms a movable end, such that the elastic arm 73 can swing freely. The elastic arm 73 is inclined toward a center of the second terminal 7 at a predetermined angle, such that the elastic arm 73 can be in flexible contact with the first terminal 2. One end (a front end) of the second contact end 71 of each of the plurality of second terminals 7 has a curved guiding surface 74, and the curved guiding surface 74 is ring-shaped and is able to guide the first contact ends 21 of the plurality of first terminal 2 to respectively insert into the second contact ends 71 of the plurality of second terminals 7. Therefore, the plurality of first terminals 2 and the plurality of second terminals 7 are smoothly inserted with each other. Preferably, a protrusion point 75 may be formed on a position on an inner side of the elastic arm 73 and adjacent to the movable end for increasing a contact conduction effect of the first terminals 2 and the second terminals 7.

The outer housing 8 is made of plastic or other materials, the outer housing 8 is disposed outside the second plastic center 6, and at least one engaging groove 81 is formed on an outer side of the outer housing 8. In this embodiment, two engaging grooves 81 are formed on the outer side of the outer housing 8 for interlocking with the two engaging bodies 52. An insertion groove 82 can further be formed between the outer housing 8 and the second plastic core 6, and the insertion groove 82 allows the sleeve portion 12 of the first plastic core 1 to insert into the insertion groove 82. Since the abovementioned locking structure is a conventional technology and are not limited in the present disclosure, it will not be iterated in detail herein.

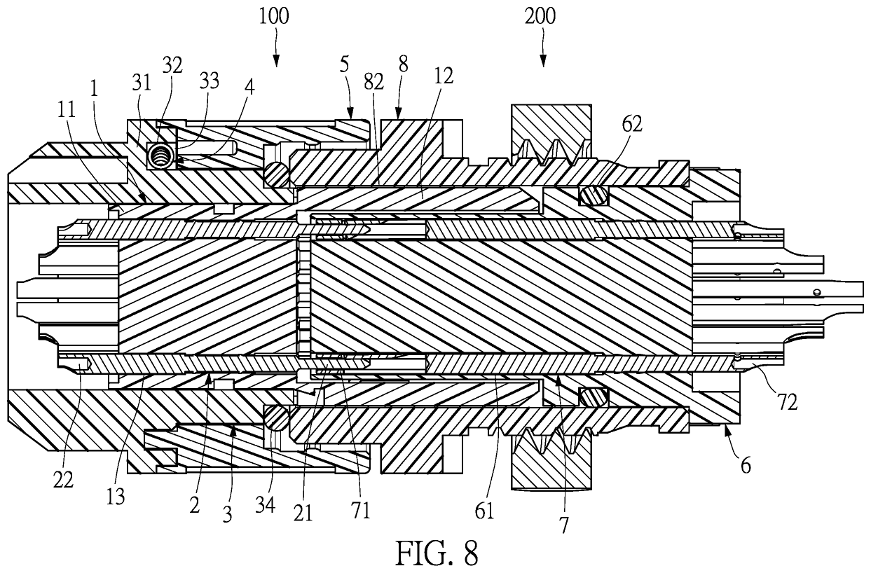

When the first connector 100 and the second connector 200 are inserted with each other (as shown in FIG. 8), the first contact terminals 21 of the first terminals 2 are respectively in electrical connection with the second contact terminals 71 of the second terminals 7, and the engaging bodies 52 and the engaging grooves 81 are able to be engaged with each other to achieve a locking function. When the first connector 100 and the second connector 200 are inserted with each other, the sleeve portion 12 of the first plastic core 1 can insert between the outer housing 8 and the second plastic core 6, such that the first connector 100 and the second connector 200 can be securely connected to each other. Furthermore, the first contact ends 21 of the first terminals 2 can insert into the second plastic core 6, such that the first connector 100 and the second connector 200 are more securely connected to each other, and the first contact ends 21 of the first terminals 2 and the second contact ends 71 of the second terminals 7 can more stably contact each other.

### Beneficial Effects of the Embodiments

In conclusion, in the electrical connection device having an automatic reset function for plugging and unplugging provided by the present disclosure, the electrical connection device includes a first connector and a second connector. The first connector includes a first plastic core, a plurality of first terminals, an inner casing member, an elastic element, and an outer casing member. The plurality of first terminals are disposed on the first plastic core, and each of the plurality of first terminals has a first contact end and a first connection end. The inner casing member is disposed outside the first plastic core, an outer side of the inner casing member has an accommodating seat disposed thereon, and the accommodating seat has an accommodating groove. An opening is formed on one side of the accommodating seat, the opening is in spatial communication with the accommodating groove, and the opening faces an axial direction of the inner casing member. The elastic element is able to be placed in the accommodating groove along the axial direction of the inner casing member through the opening, the outer casing member sleeves on the outer side of the inner casing member, two ends of the elastic element are respectively in contact with the inner casing member and the outer casing member, and an inner side of the outer casing member has at least one engaging body disposed thereon. The second connector includes a second plastic core, a plurality of second terminals, and an outer housing. The plurality of second terminals are disposed on the second plastic core, and each of the plurality of second terminals has a second contact end and a second connection end. The outer housing is disposed outside the second plastic core, and at least one engaging groove is formed on an outer side of the outer housing. When the first connector and the second connector are inserted with each other, the first contact ends of the plurality of first terminals are respectively in contact with the second contact ends of the plurality of second terminals to form an electrical connection, and the engaging body and the engaging groove are capable of being engaged with each other, such that the first connector and the second connector are fixedly locked together. In the present disclosure, the elastic element is able to be assembled to the accommodating groove along the axial direction of the inner casing member, and the outer casing member can be assembled without using any specialized assembly jig, thereby enabling a convenient and fast assembly. Furthermore, the present disclosure has a simplified structure that is conducive to manufacturing and assembly.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical connection device having an automatic reset function for plugging and unplugging, comprising:
a first connector including a first plastic core, a plurality of first terminals, an inner casing member, an elastic element, and an outer casing member, wherein the plurality of first terminals are disposed on the first plastic core, and each of the plurality of first terminals has a first contact end and a first connection end; wherein the inner casing member is disposed outside the first plastic core, an outer side of the inner casing member has an accommodating seat disposed thereon, and the accommodating seat has an accommodating groove; wherein an opening is formed on one side of the accommodating seat, the opening is in spatial communication with the accommodating groove, and the opening faces an axial direction of the inner casing member; wherein the elastic element is able to be placed in the accommodating groove along the axial direction of the inner casing member through the opening, the outer casing member sleeves on the outer side of the inner casing member, two ends of the elastic element are respectively in contact with the inner casing member and the outer casing member, and an inner side of the outer casing member has at least one engaging body disposed thereon; and
a second connector including a second plastic core, a plurality of second terminals, and an outer housing, wherein the plurality of second terminals are disposed on the second plastic core, and each of the plurality of second terminals has a second contact end and a second connection end;
wherein the outer housing is disposed outside the second plastic core, and at least one engaging groove is formed on an outer side of the outer housing;
wherein, when the first connector and the second connector are inserted with each other, the first contact ends of the plurality of first terminals are respectively in contact with the second contact ends of the plurality of second terminals to form an electrical connection, and the engaging body and the engaging groove are capable of being engaged with each other.

2. The electrical connection device according to claim 1, wherein the second contact end of each of the plurality of second terminals is hollowed, and an elastic arm is disposed on one side of the second contact end of each of the plurality of second terminals; wherein one end of the elastic arm is fixed to the second contact end, and another end of the elastic arm forms a movable end; wherein the elastic arm is inclined toward a center of the second terminal at a predetermined angle, such that the elastic arm is able to be in flexible contact with the first terminal.

3. The electrical connection device according to claim 2, wherein the first contact end of each of the first terminals can be inserted into the second plastic core; wherein one end of the second contact end of each of the plurality of second terminals has a curved guiding surface formed thereon, and the curved guiding surface is ring-shaped and is able to guide the first contact ends of the plurality of first terminals to respectively insert into the second contact ends of the plurality of second terminals.

4. The electrical connection device according to claim 2, wherein a protrusion point is formed on a position on an inner side of the elastic arm and adjacent to the movable end.

5. The electrical connection device according to claim 1, wherein the opening faces a connection direction of the first connector.

6. The electrical connection device according to claim 1, wherein the accommodating groove extends in an arc-shape, and the accommodating groove extends for a predetermined length in a circumferential direction of the inner casing member, and wherein the outer casing member has a stopping block disposed thereon, and the two ends of the elastic element abut against one end of the accommodating groove and the stopping block, respectively.

7. The electrical connection device according to claim 6, wherein an arched groove is formed in the accommodating seat, the arched groove extends in another arc-shape, and the arched groove extends for another predetermined length in the circumferential direction of the inner casing member; wherein the arched groove is in spatial communication with the accommodating groove, and the stopping block is arc-shaped and is movably disposed in the arched groove, such that the stopping block is capable of moving in the arched groove and the accommodating groove.

8. The electrical connection device according to claim 1, wherein the first rubber core includes a body portion and a sleeve portion, and one end of the sleeve portion is connected to one end of the body portion; wherein the first terminals are disposed on the body portion, and the first contact ends and the first connection ends of the first terminals respectively protrude out from two ends of the body portion; wherein the first connection ends of the first terminals extend into the inner casing member, and the first contact ends of the first terminals extend into the sleeve portion of the first plastic core; wherein an insertion groove is formed between the outer housing and the second plastic core, and the insertion groove allows the sleeve portion of the first plastic core to insert into the insertion groove.

9. The electrical connection device according to claim 8, wherein a first sealing ring sleeves on the outer side of the inner casing member, and the first sealing ring is adjacent to the sleeve portion of the first plastic core.

10. The electrical connection device according to claim 1, wherein a second sealing ring sleeves on an outer side of the second plastic core, and the second sealing ring is located between the second plastic core and the outer housing.
